(19) United States
(12) Patent Application Publication
(10) Pub. No.: US 2024/0204503 A1
(43) Pub. Date: Jun. 20, 2024

(54) COMPUTER-BASED PREVENTION OF ELECTRICAL CIRCUIT OVERLOAD

(71) Applicant: International Business Machines Corporation, Armonk, NY (US)

(72) Inventors: Bryan Edward Truong, Raleigh, NC (US); Derek Brewer, Bowling Green, OH (US); Robert Wilhelm, Cheyenne, WY (US)

(21) Appl. No.: 18/069,053

(22) Filed: Dec. 20, 2022

(51) Int. Cl. H02H 3/08; H02H 1/00; H02H 3/04

(52) U.S. Cl. CPC H02H 3/08; H02H 1/0007; H02H 1/0092; H02H 3/04

(57) ABSTRACT

Preventing overloading an electrical circuit includes determining, by one or more processors, an electrical load of an electrical circuit including a plurality of power control units each electrically connected to an electronic device and each electrically connected to an electrical output component powered through a circuit breaker set to trip at a safety threshold for the electrical circuit. The one or more processors receive from each of the power control units an electrical load status of the electrical circuit including the determined electrical load, and determine when a new electrical load corresponding to a new electronic device is added to the electrical circuit. The one or more processors determine when the new electrical load will cause the electrical load of the electrical circuit to exceed the safety threshold and, based on the determination, deny power to the new electronic device to prevent tripping the circuit breaker.

### BACKGROUND

The present invention generally relates to the field of electrical power control for electrical circuits, and more particularly to preventing overloading an electrical circuit.

Overloading an electrical circuit occurs when you demand more electricity from the electrical circuit than that particular circuit is designed to handle, this causes too much electricity going through one part of the circuit causing problems like tripped breakers, blown fuses, and fire hazards. Specifically, exceeding the rated load for the circuit wiring will trip and open up the circuit breaker, which shuts off the power supply to that circuit, cutting off electricity. Thus, there is a need for improved ways to prevent circuit overload.

### SUMMARY

Shortcomings of the prior art are overcome and additional advantages are provided through the provision of a computer-implemented method for preventing electrical circuit overload. The method includes determining, by one or more processors, an electrical load of an electrical circuit, the electrical circuit including a plurality of power control units each electrically connected to an electronic device, the plurality of power control units each being electrically connected to an electrical output component powered through a circuit breaker set to trip at a safety threshold for the electrical circuit, receiving, by the one or more processors, from each of the power control units an electrical load status of the electrical circuit including the determined electrical load, determining, by the one or more processors, using the received electrical load status from each of the power control units, when a new electrical load is added to the electrical circuit, the new electrical load corresponding to a new electronic device, determining, by the one or more processors, when the new electrical load will cause the electrical load of the electrical circuit to exceed the safety threshold, and responsive to determining that the new electrical load will cause the electrical load of the electrical circuit to exceed the safety threshold, denying, by the one or more processors, power to the new electronic device to prevent tripping the circuit breaker.

Another embodiment of the present disclosure provides a computer system for preventing electrical circuit overload, based on the method described above.

Another embodiment of the present disclosure provides a computer program product for preventing electrical circuit overload, based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 depicts a computer system for preventing electrical circuit overload, according to an embodiment of the present disclosure;

FIG. 3 depicts a detailed view of a Power Control Unit for preventing electrical circuit overload, according to an embodiment of the present disclosure; and

FIG. 4 depicts a flowchart illustrating the steps of a computer-implemented method for preventing electrical circuit overload, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

There are often situations in which a device or appliance may cause an electrical circuit to overload when the device/appliance is powered on, causing the circuit breaker to trip. This may require manually resetting the circuit breaker. The simplest way to prevent the circuit breaker from tripping is to not overload the electrical circuit. However, the challenge of preventing circuit overload lies in the difficulty in knowing whether the electrical circuit is already being heavily utilized. Embodiments of the present disclosure utilize Power Control Units (PCUs) to facilitate identifying whether the electrical circuit is approaching its maximum electrical load. The proposed PCUs can automatically prevent new devices from being powered ON within the electrical circuit when the electrical circuit is already powering multiple other devices that consume much of the circuit's load.

The following described exemplary embodiments provide a method, system, and computer program product to, among other things, prevent overloading an electrical circuit by using a Power Control Unit (PCU) that acts as a middleman between electronic devices that look to be plugged-in and electrical outlets of the electrical circuit. The proposed PCU can be plugged into an electrical outlet, with the electronic device that is looking to gain access to the electrical circuit plugging into the PCU, rather than the actual electrical outlet. In some embodiments, the PCU can be a built-in feature within the electronic device. The role of the PCU device is to act as gatekeeper to the electrical circuit, preventing the newly plugged-in electronic device from having access to the electrical circuit (and thereby adding to the circuit's load) in situations where it is deemed highly likely to cause the electrical circuit to overload and/or the circuit breaker to trip. In one or more of the proposed embodiments, the PCU may be able to communicate with other sibling PCUs and determine whether the newly plugged-in electronic device it is controlling should be granted access to the electrical circuit, based on reporting from its sibling PCU devices. The means of communication between the PCUs can be configured in a variety of ways, whether it be by power line communication, Wi-Fi, Bluetooth, etc.

Thus, the present embodiments have the capacity to improve the technical field of Internet Of Things (IOT) by providing a Power Control Unit (PCU) device capable of determining a current electrical load of the electrical circuit and based on the determined electrical load of the electrical circuit, automatically preventing or allowing additional electronic devices to be plugged-in. More particularly, the proposed PCU device is capable of communicating with other PCUs to prevent combinations of high-powered electronic devices that can consume significant electrical loads from simultaneously gaining access to the electrical circuit.

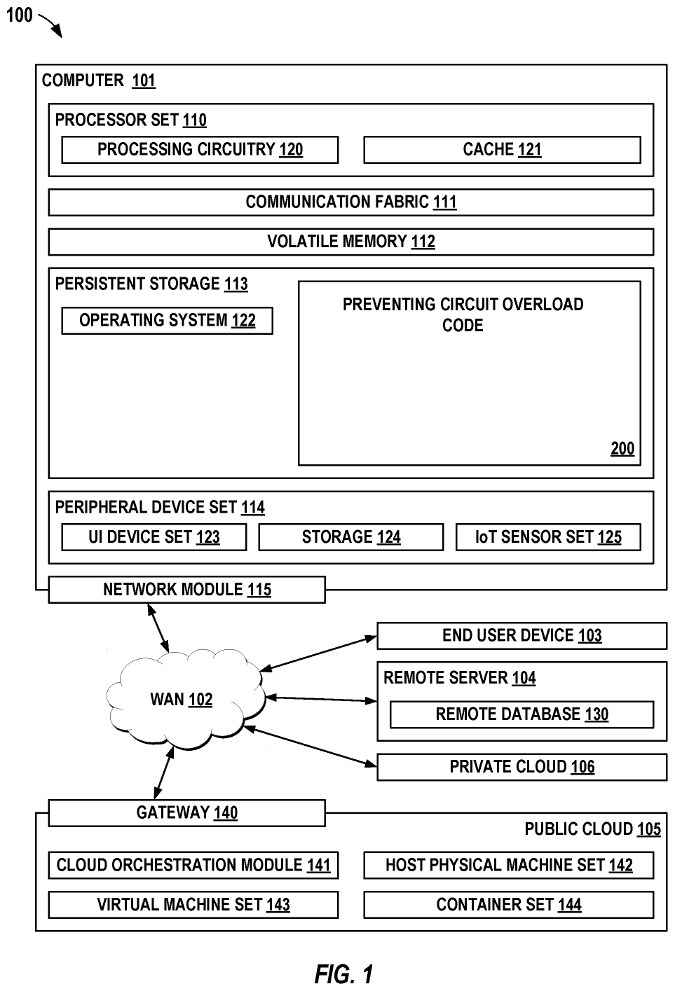

Referring now to FIG. 1, an exemplary computing environment 100 is depicted, according to an embodiment of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the preventing circuit overload code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and eache 121), communication fabric 111, volatile memory 112, persistent storage 113 (including operating system 122 and block 200, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the eache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as eache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

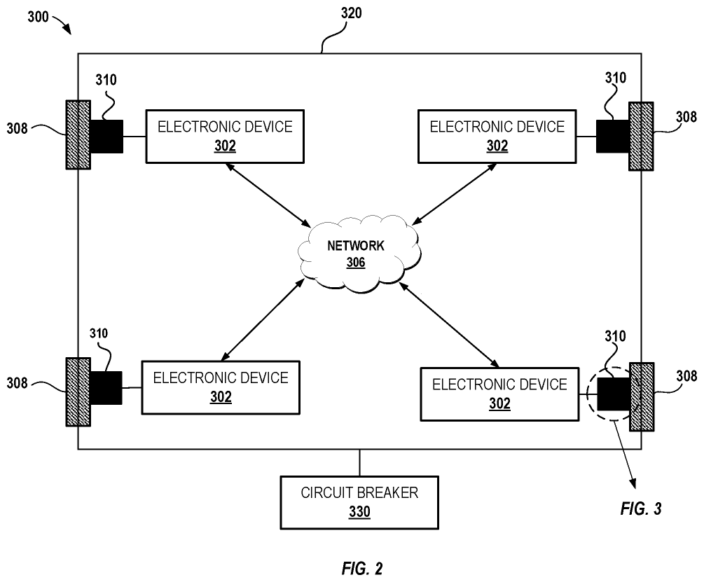

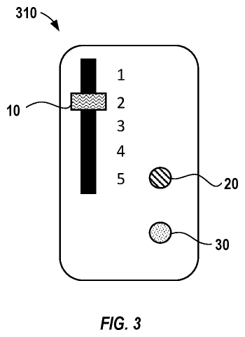

Referring now to FIG. 2 and FIG. 3 simultaneously, components of a computer system 300 for preventing electrical circuit overload are shown, according to an embodiment of the present disclosure. In this embodiment, FIG. 3 is a detailed view of an example Power Control Unit (PCU) 310 for determining an electrical load and preemptively stopping one or more of electronic devices 302 from gaining access to electrical circuit 320.

According to an embodiment, the computer system 300 includes a plurality of electronic devices 302 (hereinafter “electronic devices”) communicatively connected via a network 306. Each of the electronic devices 302 may include an IoT device capable of communicating with other IoT devices within the computer system 300 or outside the computer system 300 via the network 306. Network 306 may include wide area network (WAN) 102 depicted in FIG. 1. Electronic devices 302 may also be communicatively connected to PCUs 310 via network 306. For illustration purposes only, without intent of limitation, only four electronic devices 302 are depicted in FIG. 2. It may be understood that electrical circuit 320 may include more or less electronic devices 302, depending on an electrical load capacity of the electrical circuit 320.

Each electronic device 302 is connected to an electrical output component or electrical outlet 308 (e.g., outlets, electrical sockets, plugs, wall plugs, etc.) part of electrical circuit 320. Each electrical outlet 308 is powered through a circuit breaker 330. As known by those skilled in the art, circuit breaker 330 is an electrical switch designed to protect an electrical circuit (e.g., electrical circuit 320) from damage caused by overcurrent/overload or short circuit. Its basic function is to interrupt current flow after protective relays detect a fault.

In the depicted embodiment, each of the electronic devices 302 is electrically connected or plugged into a PCU 310, and each PCU 310 is plugged into a corresponding electrical outlet 308. Thus, electronic devices 302 looking to gain access to the electrical circuit 320 are plugged into a corresponding PCU 310, rather than the electrical outlet 308. In some embodiments, PCUs 310 can be a built-in feature within each of the electronic devices 302.

Accordingly, each PCU 310 may act as gatekeeper to the electrical circuit 320 for preventing a newly plugged-in electronic device 302 from having access to the electrical circuit 320 and adding to the circuit's load when it is likely that plugging in a new electronic device can cause the electrical circuit 320 to overload and/or the circuit breaker 330 to trip. In one or more embodiments, each PCU 310 in computer system 300 may be able to communicate with other sibling PCUs 310 to determine whether a newly plugged-in electronic device 302 should be granted access to the electrical circuit 320, based on electrical load information received from its sibling middleman devices. In one or more embodiments, electronic devices 302 and PCUs 310 are communicatively connected via network 306. The means of communication between the PCUs 310 can be configured in a variety of ways including, but not limited to, power line communication, Wi-Fi, Bluetooth, etc.

According to an embodiment, each PCU 310 allows defining a number of electronic devices 302 that can be concurrently powered ON. This may be achieved via a multi-position or selector switch 10 (depicted in FIG. 3) available on the pluggable PCUs 310. In some embodiments, settings for the PCUs 310 can be established or defined using an external app (e.g., running on a user device) and communicated to each PCU 310. Preferably, all PCUs 310 are aware of a status of all other PCUs 310 within network 306. Specifically, each PCUs 310 may, in real-time, determine an electrical load of the electrical circuit 320, and based on the determined electrical load identify a current electrical load status of each electronic device 302 for allowing powering ON at least one additional electronic device 302. If the status of all the electronic devices 302 on network 306 allows for powering ON of at least one additional electronic device 302 without affecting the circuit breaker 330, the PCU 310 corresponding to such electronic device 302 may display a status LED 30 indicating the additional electronic device 302 can join the electrical circuit 320 and allows for power to be turned ON.

If the electrical load status of electronic devices 302 does not allow for powering ON at least one additional electronic device 302, as it would affect the circuit breaker 330, the PCU 310 corresponding to that additional electronic device 302 may display a status LED 30 indicating the additional electronic device 302 cannot join the electrical circuit 320 and denies power to the additional electronic device 302 looking to be powered ON.

In some embodiments, the electronic devices 302 may include a device or unit that does not need to be kept constantly plugged (e.g., a vacuum cleaner). In such embodiments, logic within the PCUs 310 may introduce a delay as needed when a user attempts to turn on the device. This delay is intended to allow the PCUs 310 to determine the status of other electronic devices 302 on network 306 and determine if it is acceptable to allow power. A further embodiment may allow the PCUs 310 to remotely power off a different PCU 310 as needed. For example, a PCU 310 on a vacuum cleaner can be set to remotely turn off a PCU 310 of a TV if required to avoid overloading circuit breaker 330.

With continued reference to FIG. 3, an example design of the PCUs 310 may include a PCU plug (not shown) for insertion into power outlets 308, a PCU outlet (not shown) for insertion of a plug from another device (e.g., electronic devices 302), network connectivity components (Wi-Fi, Bluetooth, etc.), and components for controlling whether power is or is not provided to the attached electronic device 302. Physical switches such as selector switch 10 on the PCUs 310 may be considered optional, as configuration of PCUs 310 may be set solely via an external app.

The PCUs 310 may include one or more status LEDs, such as power status LED 30 for showing an electrical load status of concurrent electronic devices 302 on network 306 in relation to whether a current device may be powered ON and network connection status LED 20 for indicating a network connectivity status.

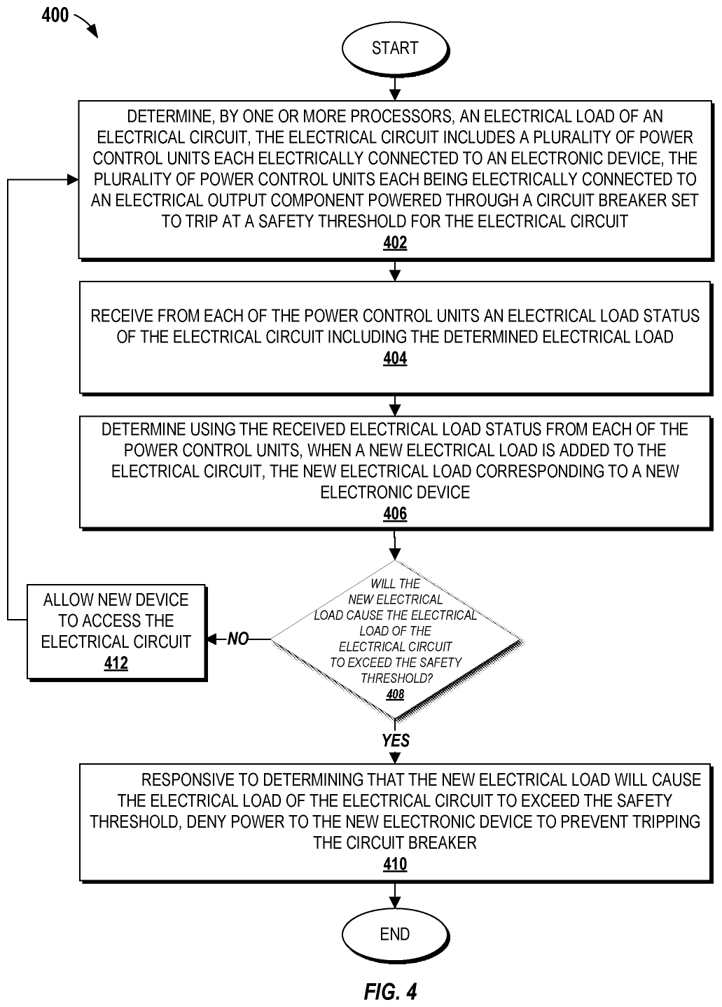

Referring now to FIG. 4, a flowchart 400 illustrating the steps of a computer-implemented method for preventing electrical circuit overload is shown, according to an embodiment of the present disclosure.

According to an embodiment, the method starts at step 402 by determining, by one or more processors, an electrical load of an electrical circuit 320. The electrical circuit 320 including a plurality of power control units 310 each electrically connected to an electronic device 302. The plurality of power control units 310 each being electrically connected to an electrical output component or electrical outlet 308 powered through a circuit breaker 330 set to trip at a safety threshold for the electrical circuit 320. In an exemplary embodiment, electronic device 302 includes an IoT device capable of communicating with each power control unit 310. Specifically, each power control unit 310 is electrically connected to a respective electronic device 302 (as depicted in FIG. 2), and each power control unit 310 is communicatively connected to all power control units 310 within a network 306 and communicatively connected to each respective electronic device 302. In one or more embodiments, each power control unit 310 is plugged into a corresponding electrical outlet 308, and each electronic device 302 is plugged into a respective power control unit 310. In some embodiments, the power control unit 310 is a built-in feature within each electronic device.

The method continues at step 404 by receiving from each of the power control units 310 an electrical load status of the electrical circuit 320 including the determined electrical load. The electrical load status indicating a current load capacity of the electrical circuit 320 for allowing more electronic devices 302 to have access to the electrical circuit. In one or more embodiments, each power control 310 unit further includes a selector switch 10 for allowing one or more users to set a preference including a number of electronic devices 302 to be concurrently powered on by the electrical circuit 320. In other embodiments, the preference set by the one or more users is further established using an external app running on a user device and communicated to each power control unit 310. In one or more embodiments, a priority to access the electrical circuit 320 can be establish for each electronic device 302 via, for example, the external app running on the user device. In such embodiments, each power control unit 310 is configured to deny power to a lowest priority electronic device 302 at the electrical outlet 308 to prevent a trip of the circuit breaker 330.

At step 406, using the received electrical load status from each power control unit 310, the method determines when a new electrical load is added to the electrical circuit 320, the new electrical load corresponding to a new electronic device 302. At step 408, the method determines whether the new electrical load will cause the electrical load of the electrical circuit 320 to exceed the safety threshold. In one or more embodiments, the safety threshold can be predefined by a user using, for example, the external app.

Responsive to determining that the new electrical load will cause the electrical load of the electrical circuit 320 to exceed the safety threshold, the method, at step 410, preemptively denies or stops power to the new electronic device 302 for preventing the circuit breaker 330 to trip. In embodiments in which the newly added load will not cause the determined electrical load of the electrical circuit 320 to exceed the safety threshold, the method, at step 412, allows the new device 302 to access the electrical circuit 320.

In one or more embodiments, the method further includes each of the power control units 310 displaying the electrical load status of each electronic device 302 using a first LED indicator 30 available within the plurality of power control units 310 for indicating whether a new electronic device 302 can or cannot be powered on, and displaying a network connectivity status using a second LED indicator 20 also available within the plurality of power control units 310.

Thus, the previously described embodiments provide a computer system and method to prevent overloading of an electrical circuit, the electrical circuit including two or more electronic devices, two or more electrical outlets powered through one circuit breaker, with each electronic device being plugged into a power control unit, and the power control unit being plugged into an electrical outlet. Each power control unit is configured to monitor the status of the electrical circuit, including an electrical load from each electronic device based on information from all power control units within the same network, display a status indicator of the electrical circuit, determine a new electrical load is added to the electrical circuit (e.g., plugging in a new electronic device), and preemptively deny power to the newly added device in response to determining that the added load may cause the circuit breaker to trip.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for preventing electrical circuit overload, comprising:
determining, by one or more processors, an electrical load of an electrical circuit, the electrical circuit including a plurality of power control units each electrically connected to an electronic device, the plurality of power control units each being electrically connected to an electrical output component powered through a circuit breaker set to trip at a safety threshold for the electrical circuit;
receiving, by the one or more processors, from each of the power control units an electrical load status of the electrical circuit including the determined electrical load;
determining, by the one or more processors, using the received electrical load status from each of the power control units, when a new electrical load is added to the electrical circuit, the new electrical load corresponding to a new electronic device;
determining, by the one or more processors, when the new electrical load will cause the electrical load of the electrical circuit to exceed the safety threshold; and
responsive to determining that the new electrical load will cause the electrical load of the electrical circuit to exceed the safety threshold, denying, by the one or more processors, power to the new electronic device to prevent tripping the circuit breaker.

2. The computer-implemented method of claim 1, wherein the electronic device includes an IoT device capable of communicating with each power control unit.

3. The computer-implemented method of claim 1, wherein each power control unit is electrically connected to a respective electronic device, and each power control unit is communicatively connected to all power control units within a network and communicatively connected to each respective electronic device.

4. The computer-implemented method of claim 1, wherein the electronic device includes a priority to access the electrical circuit.

5. The computer-implemented method of claim 4, wherein each power control unit is configured to deny power to a lowest priority electronic device at the electrical output component to prevent a trip of the circuit breaker.

6. The computer-implemented method of claim 1, wherein each power control unit is plugged into a corresponding electrical output component, and each electronic device is plugged into a corresponding power control unit.

7. The computer-implemented method of claim 1, wherein the power control unit is a built-in feature within the electronic device.

8. The computer-implemented method of claim 1, wherein each power control unit further includes a selector switch for allowing one or more users to set a preference including a number of electronic devices to be concurrently powered on by the electrical circuit.

9. The computer-implemented method of claim 8, wherein the preference set by the one or more users is further established using an external app running on a user device and communicated to each power control unit.

10. The computer-implemented method of claim 1, wherein each power control unit further includes a first LED indicator and a second LED indicator for:
displaying, by the one or more processors, the electrical load status of each electronic device using the first LED indicator within the plurality of power control units for indicating whether a current electronic device can be powered on; and
displaying, by the one or more processors, a network connectivity status using the second LED indicator within the plurality of power control units.

11. A computer system for preventing electrical circuit overload, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
determining, by one or more processors, an electrical load of an electrical circuit, the electrical circuit including a plurality of power control units each electrically connected to an electronic device, the plurality of power control units each being electrically connected to an electrical output component powered through a circuit breaker set to trip at a safety threshold for the electrical circuit;
receiving, by the one or more processors, from each of the power control units an electrical load status of the electrical circuit including the determined electrical load;
determining, by the one or more processors, using the received electrical load status from each of the power control units, when a new electrical load is added to the electrical circuit, the new electrical load corresponding to a new electronic device;
determining, by the one or more processors, when the new electrical load will cause the electrical load of the electrical circuit to exceed the safety threshold; and
responsive to determining that the new electrical load will cause the electrical load of the electrical circuit to exceed the safety threshold, denying, by the one or more processors, power to the new electronic device to prevent tripping the circuit breaker.

12. The computer system of claim 11, wherein the electronic device includes an IoT device capable of communicating with each power control unit.

13. The computer system of claim 11, wherein each power control unit is electrically connected to a respective electronic device, and each power control unit is communicatively connected to all power control units within a network and communicatively connected to each respective electronic device.

14. The computer system of claim 11, wherein the electronic device includes a priority to access the electrical circuit.

15. The computer system of claim 14, wherein each power control unit is configured to deny power to a lowest priority electronic device at the electrical output component to prevent a trip of the circuit breaker.

16. The computer system of claim 11, wherein each power control unit is plugged into a corresponding electrical output component, and each electronic device is plugged into a corresponding power control unit.

17. The computer system of claim 11, wherein the power control unit is a built-in feature within the electronic device.

18. The computer system of claim 11, wherein each power control unit further includes a selector switch for allowing one or more users to set a preference including a number of electronic devices to be concurrently powered on by the electrical circuit.

19. The computer system of claim 18, wherein the preference set by the one or more users is further established using an external app running on a user device and communicated to each power control unit.

20. The computer system of claim 11, wherein each power control unit further includes a first LED indicator and a second LED indicator for:
displaying, by the one or more processors, the electrical load status of each electronic device using the first LED indicator within the plurality of power control units for indicating whether a current electronic device can be powered on; and
displaying, by the one or more processors, a network connectivity status using the second LED indicator within the plurality of power control units.
